(19) United States
(12) Patent Application Publication
(10) Pub. No.: US 2022/0099866 A1
(43) Pub. Date: Mar. 31, 2022

(54) LENS MODULE

(71) Applicant: SICK AG, Waldkirch (DE)

(72) Inventors: Thomas PFRENGLE, Waldkirch (DE); Jakob BURGER, Waldkirch (DE)

(21) Appl. No.: 17/400,369

(22) Filed: Aug. 12, 2021

(30) Foreign Application Priority Data
Sep. 29, 2020 (DE) 102020125369.9

(51) Int. Cl. G02B 3/14

(52) U.S. Cl. CPC G02B 3/14

(57) ABSTRACT

A lens module (38) is provided that has a module housing (42) having a base (44) and a side wall (46), an adaptive lens (40) variable in its focal length in the module housing (42), and a pressing element (48) to hold the adaptive lens (40) in the module housing (42), The pressing element has a wave spring (48) here.

The invention relates to a lens module having an adaptive lens, to an objective, and to an optoelectronic sensor.

A transmission optics or reception optics is provided in practically every optical sensor. This optics is frequently focused to a specific distance or distance range with the aid of a focal adjustment in that the position of the lenses and thus the back focal length focal length of the transmission optics or reception optics is adjusted electromechanically or optomechanically, for example using stepper motors or moving coils. Such solutions require a lot of construction space and additionally make high demands on the mechanical design for the precise adjustability so that a predefined focal position is also actually adopted.

An alternative is the use of optics in which it is not the back focal length which is varied, but rather directly the shape and thus the focal length of the lens itself by means of a voltage control. Gel lenses or liquid lenses are in particular used for this purpose. With a gel lens, a silicone-like liquid is mechanically deformed by means of piezoelectric or inductive actuators. Liquid lenses, for example, utilize the so-called electrowetting effect in that two non-miscible liquids, preferably of similar densities, but having different refractive indices and electrical properties, are disposed above one another in a chamber. When a control voltage is applied, the two liquids change their surface tensions in different manners so that the inner boundary surface of the liquids varies its curvature in dependence on the voltage.

An adaptive lens has to be installed in a suitable manner in an objective and then into a sensor together with the objective. In order not to have to adapt the total design to the adaptive lens, the use of standard objectives should be possible. A pressing on with a defined force is necessary for the integration of the adaptive lens.

A conventional solution provides for the use of an O ring of rubber or of another elastic material for this purpose. Fixing its properties such as the cord thickness or Shore hardness, over all the tolerances, aging of the material, and the provided temperature range so exactly that the pressing force remains in the required range is not possible of a series of larger volumes. The result is contact problems with too little a force and possible damage to the adaptive lens with too great a force. To better control the force and to be less sensitive to tolerances, the O ring can additionally be screwed with a threaded ring. It also remains difficult in this process to keep the force constant over the temperature range. In addition, the adaptive lens requires a connection lead that is led out to the side and its position is changed during the screwing. The position displacement could be prevented or compensated by defined thread starts or by a longer connection lead using folding techniques, but that is time consuming and unsatisfactory.

It is furthermore known to install the adaptive lens in a module and in so doing to hold the O ring in position by a securing ring. However, this does not solve the problems described; the force distribution is not uniform and is furthermore subject to said tolerances. There are furthermore difficulties in positioning the adaptive lens close enough to the objective and to align it on its optical axis. An additional injection molded plastic part can be used for the centering, with then, however, the objective having to be shaped such that the injection molded plastic part can be attached in the intended manner. The construction size is additionally increased in diameter.

A spring of a bent sheet metal part is known as an alternative to an O ring This does not require any special production of the spring with a complex configuration. In addition, the bent sheet metal part can bend on installation and a force change can thus be caused. It is furthermore known to mount the adaptive lens with a stamped bent part on a circuit board. The described disadvantages of the complex individual configuration and production and possible force changes are, however, not overcome thereby. The optical axis can furthermore be decentered by temperature effects.

An adjustment device for the lens of a camera module is known from US 2006/004 4455 A1 in which a wave spring Is also used in addition to numerous other elements. In U.S. Pat. No. 7,616,388 B2, a lens can be moved to and fro in a holder by rotating a thread, with a wave spring being provided above the thread. JP4419417 B2 shows a further focus adjustment with a spiral spring, a plate spring, or a wave spring. The construction challenges here are, however, not comparable, because the lens has to be moved as a whole in every case for the focusing. An adaptive lens, in contrast, remains in a fixed position and also has to be held in this manner since the focusing is here based on a focal length change. EP 0 098 540 A2 shows a wave spring in an axially displaceable condenser of a microscope where the technical difference from a liquid lens becomes even greater.

US 2013/0229617 A1 deals with eyeglasses having a variable focus. A wave spring whose function is, however, not to hold an adaptive lens in its position by a well defined force is arranged in an actuator to generate a linear movement.

It is therefore the object of the invention to improve the installation of an adaptive lens.

This object is satisfied by a lens module in accordance with the respective independent claim. An adaptive lens whose focal length is variable, for example, by applying control signals or control voltages to at least one electrode of the adaptive lens is accommodated in a module housing that has a base and a side wall. A pressing element holds the adaptive lens in the module housing in that it exerts a force onto the adaptive lens from above by which the adaptive lens is pressed toward the base. Directional terms such as base, that is a lower side, or from above relate to a specific view and are to be understood as relative since the lens module as a whole can naturally be rotated as desired.

The invention starts from the basic idea of using a wave spring as the pressing element. Such wave springs are used in ball bearings, for example. A precision wave spring of a ball bearing producer can therefore be used. The wave spring provides a well defined pressing force that changes due to tolerances, temperature effects, or aging phenomena.

Said components, that is the adaptive lens, module housing with base and side wall, and wave spring, are preferably of cylindrical or annular shape and are thus approximately rotational bodies with respect to the optical axis. This only applies approximately because connections, cutouts, or, in the case of the wave spring, the defining axial wave form, differ from an exact rotational body. This preferred shape also relates to most of the elements for optional designs of the invention presented in the following.

The invention has the advantage that a modular integration of the adaptive lens for different standard objectives is made possible thanks to the lens module. The assembly complexity is substantially reduced. A secure connection and contacting over the total industrial temperature range is provided without exceeding or falling below the required pressing force. The different elements such as the module housing and the wave spring can be designed as metal parts so that more temperature sensitive plastic is avoided. Small construction sizes can be achieved, The spring loaded adaptive lens also permits the use of the lens module and of an objective built up thereof or of a sensor in a rough industrial environment with shocks and vibrations.

The adaptive lens is preferably a liquid lens or a gel lens and in particular has two non-miscible media whose mutual boundary surface has, due to application of a voltage, a curvature corresponding to the voltage. Such lenses provide the desired setting possibilities of the focal position and are very small in construction and inexpensive in this respect.

The adaptive lens preferably has at least one electrode and the lens module has a connection lead, in particular a flexible cable, to contact the electrode from outside the module housing. The adaptive lens is controlled to adapt its focal length via the at least one electrode. The connection lead provides a connection to the outside of the module housing. The connection lead is preferably designed as a flexible cable.

The lens module preferably has a temperature sensor that is in particular formed as a resistor on the connection lead. Knowledge of the temperature is useful, for example, for a temperature compensation of the control signals to set a focal length. The design as a resistor on the connection lead is particularly compact and simple.

The lens module preferably has an insulation element between the adaptive lens and the wave spring that is in particular simultaneously configured as an assembly element for inserting the adaptive lens into the module housing. In conventional solutions with an O ring, no insulation is required. A metallic and consequently conductive wave spring could, however, cause a short-circuit between the electrodes of the adaptive lens or of the connection lead. The insulation element can be given an additional function in that it provides the correct location of the adaptive lens on the assembly.

The lens module preferably has a pressing element for pressing the wave spring onto the adaptive lens. The pressing element designed, for example, as a pressing ring, presses onto the wave spring so that it is tensioned and exerts the desired spring force on the adaptive lens. The pressing element is in turn pressed, for example in the installed state of the lens module with an objective, and transmits this force on to the wave spring.

The pressing element, wave spring, insulation element, adaptive lens, and base are preferably arranged above one another in this order. As already mentioned, directional terms such as above one another are to be understood as relative based on the idea that the base of the module housing faces downward. If one of said elements is omitted in some embodiments, the remaining elements preferably maintain said same order.

In a preferred further development, an objective is provided having a lens module in accordance with the invention, with the lens module being pressed onto the objective or its connection piece (barrel, tube) by a second spring. The lens module can be used for different object variants due to the modular design. The assembly is very simple and preferably tool-less and a compact construction shape results.

The second spring is preferably formed as a multiturn spring. The second spring can thus act at different distances between the lens module and a counter-hold of the second spring, for example a front screen. The same lens module can thus be used while using the same second spring at least to a certain extent for objectives of different sizes; different objective focal lengths with different distances are made possible. If the distance becomes too great, the use of another second spring can become necessary.

A clearance fit for a rotation of a connection lead of the lens module into the correct position is preferably provided between the lens module and the objective or its connection piece or barrel. The lateral orientation of the connection lead can be set and corrected very easily by the clearance fit.

The objective preferably has an extraneous light filter that is arranged above the second spring. Above is again to be understood relatively in an orientation of the lens module with its base to the bottom and a seating of the base on the objective or its connection pieces. The extraneous light filter is accordingly located on a side of the second spring disposed opposite the lens module and the objective and the order is, from below, the objective, the lens module, the second spring, and the extraneous light filter.

In an preferred further development, an optoelectronic sensor having a light transmitter and/or a light receiver has an objective in accordance with the invention arranged upstream of the light transmitter and/or the light receiver. The lens module makes an exact positioning of the adaptive lens on the optical axis possible. The optoelectronic sensor is, for example, a camera having an image sensor as the light receiver and an objective in accordance with the invention arranged upstream or a barcode scanner whose reading beam is shaped by an objective in accordance with the invention.

The objective is preferably pressed toward a front screen of the sensor by the second spring. The order thus results of objective (connection piece or barrel), lens module, second spring, front screen, with an optional extraneous light filter being arranged in front of the front screen. Since the front screen is pressed onto the second spring, the required spring force is produced that ultimately holds the adaptive lens at the base of the module housing with a well defined force that is permanently present in the desired region.

The invention will be explained in more detail in the following also with respect to further features and advantages by way of example with reference to embodiments and to the enclosed drawing. The Figures of the drawing show in:

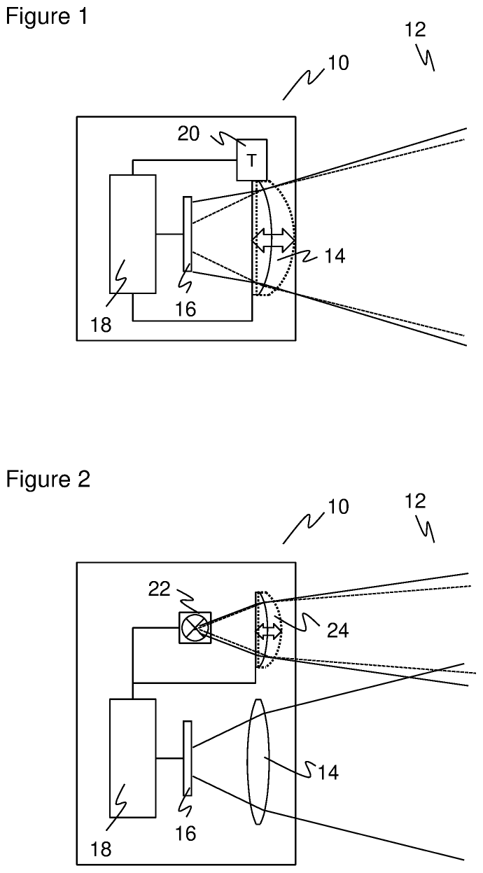

FIG. 1 a schematic sectional representation of an optoelectronic sensor with an adaptive lens in the reception optics;

FIG. 2 a schematic sectional representation of an optoelectronic sensor with an adaptive lens in the transmission optics;

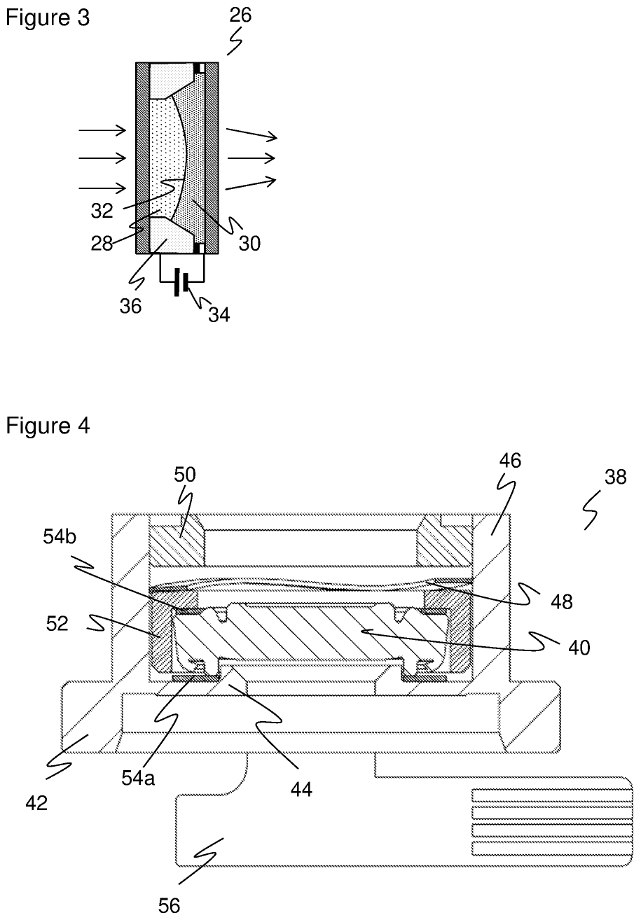

FIG. 3 a schematic representation of an adaptive lens in accordance with the invention;

FIG. 4 a sectional representation of a lens module;

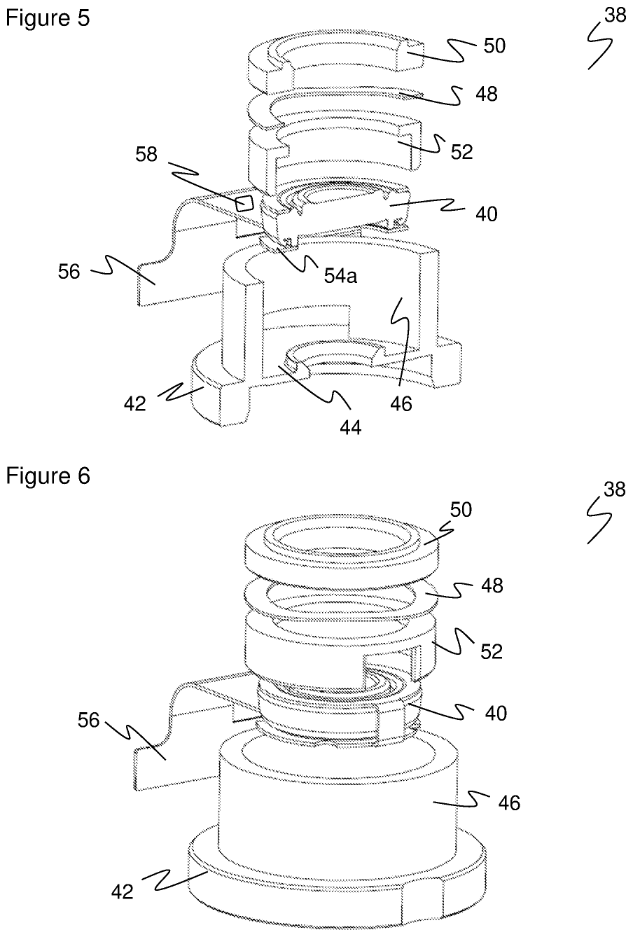

FIG. 5 a cut-away three-dimensional representation of the lens module in accordance with FIG. 4;

FIG. 6 a three-dimensional representation of the lens module in accordance with FIGS. 4 and 5; and

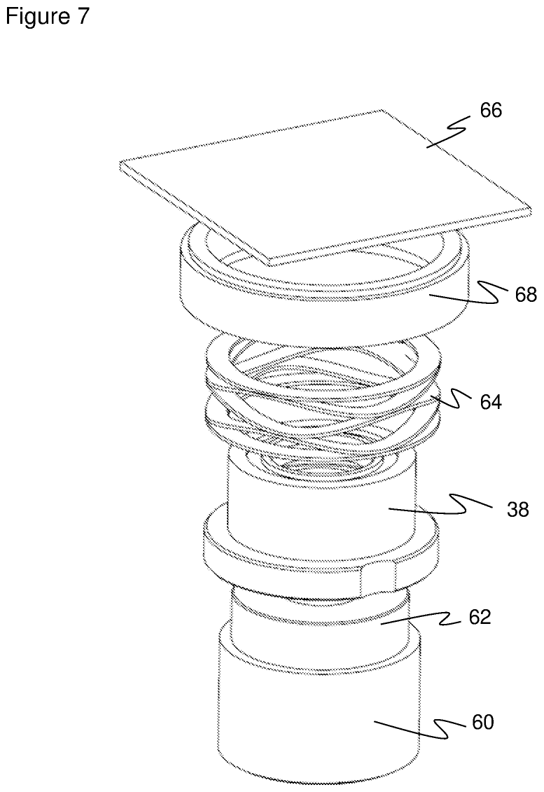

FIG. 7 a three-dimensional representation of the lens module in accordance with FIGS. 4 to 6 together with an installed lens module at the objective.

FIG. 1 shows a schematic sectional representation of an optoelectronic sensor for detecting object information from a monitored zone 12. An image sensor 16, for example a CCD or CMOS chip, generates recordings of the monitored zone 12 via a reception optics 14. The image data of these shots are forwarded to a control and evaluation unit 18.

The reception optics 14 has an adaptive lens whose focal length can be changed by an electronic control of the control and evaluation unit 18. FIG. 1 shows by dashed lines by way of example an alternative focal length setting and the functional principle of a conceivable design of the adaptive lens will be explained in more detail below with reference to FIG. 3. A temperature sensor 20 is connected to the control and evaluation unit and is arranged such that it is at least indirectly in thermal connection with the adaptive lens.

FIG. 2 shows a further embodiment of the optoelectronic sensor 10. This embodiment differs from the embodiment shown in FIG. 1 by a light transmitter 22 having a transmission optics 24. The adaptive lens is now part of the transmission optics 24; the reception optics 14 has a fixed focal position. A temperature sensor 20 as in FIG. 1 is also possible for the adaptive lens of the transmission optics 24 in the embodiment of FIG. 2. Mixed forms of the embodiments in accordance with FIG. 1 and FIG. 2 are furthermore conceivable in which the reception optics 14 and the transmission optics 24 have an adaptive lens or a common optics is provided having an adaptive lens for the image sensor 16 and for the light transmitter 22, with the adaptive lens in turn being able to have a temperature sensor 20. In addition, a light transmitter 22 having a transmission optics without an adaptive lens can be added in FIG. 1, for example to illuminate the monitored zone 12 or to generate a light signal whose time of flight is determined for the distance measurement.

FIGS. 1 and 2 are therefore schematic diagrams that are representative for a plurality of sensors. The sensor 10 in accordance with FIG. 1 is, for example, a camera with a variable focus that is inter alia suitable in a variety of applications for the inspection and measurement of objects, preferably in a stationary installation at a conveyor system that moves the objects through the monitored zone 12. A barcode scanner or a camera-based code reader arises by the use of signal processing or image processing known per se for the reading of codes. The image sensor 16 can have a linear arrangement or a matrix arrangement of pixels. In further embodiments, a different light receiver instead of the image sensor 16 is used, for example a photodiode or an APD (avalanche photodiode). The latter is, for example, used in a light sensor, in particular a distance measuring light sensor, or in a laser scanner.

The light transmitter 22 can also satisfy a variety of functions. For example, with the aid of the transmission optics 24, a specific illuminated monitored zone 12 is set, a sharp contrast pattern, a sharp target pattern to mark a recording or reading zone, or a sharp light spot is projected at a specific distance. Such different sensors 10 as a camera-based code reader, a code scanner, or a 3D camera are thus conceivable.

FIG. 3 shows the adaptive lens of the reception optics 14 or of the transmission optics 24 in an exemplary embodiment as a liquid lens 26 after the electrowetting effect. It is here only a question of the functional principle; the specific design and construction shape may differ. The operation will be explained with reference to this liquid lens 26, but the invention also comprises other adaptive lenses, for example those having a liquid chamber and having a membrane which covers it and whose curvature is varied by pressure on the liquid, or having lenses with a gel-like, optically transmitting material which is mechanically deformed by an actuator.

The actively tunable liquid lens 26 has two transparent, non-miscible liquids 28, having different refractive indices and having the same densities. The shape of the liquid boundary layer 32 between the two liquids 28, 30 is used for the optical function. The activation is based on the principle of electrowetting which shows a dependence of the surface tension or of the boundary surface tension on the applied electrical field. It is therefore possible to vary the shape of the boundary layer 32 and thus the optical properties of the liquid lens 26, by an electric control at a terminal 34, whereby corresponding voltages are applied to an electrode 36. In addition to an adjustment of the focal length, a tilting is also conceivable for which purpose then at least one further electrode is provided at the liquid lens 26.

FIGS. 4 to 6 show a lens module 38 having an adaptive lens 40 in a sectional representation, a cut-away three-dimensional representation, and a three-dimensional representation from the outside. The adaptive lens 40 can be a liquid lens, as described with respect to FIG. 3, or can use a different principle for the adjustment of the focal length. The adaptive lens 40 is accommodated in a module housing 42 having a base 44 and a side wall 46. A wave spring 48 presses the adaptive lens 40 downwardly toward the base 44. The wave spring 48 is in turn pressed from above by a pressing ring 50. An insulation element 52 is arranged between the wave spring 48 and the adaptive lens 40.

As can in particular be recognized in the three-dimensional representations of FIGS. 5 and 6, said components are cylindrical or are designed as a ring and are at least approximately shaped as rotational bodies about the optical axis.

Electrodes 54a-b of the adaptive lens 40 are contacted by a connection lead 56 designed as a flexible cable so that the electrodes 54a-b can be controlled laterally from outside the lens module 38. An optional resistor 58 on the connection lead 56 is shown in FIG. 5 that serves as a temperature sensor.

In accordance with the invention, the adaptive lens 40 is spring loaded by the wave spring 48, i.e. is pressed toward the base 44 by a defined force. It thus replaces the conventional tolerance-critical O ring and avoids the disadvantages associated therewith. The wave spring 48 is preferably of metal and is, for example, a precision wave spring of a ball bearing producer. The advantage comprises the characteristic line of the wave spring 48 extending almost linearly and practically no fluctuations of the exerted force occurring over the total industrial temperature range. An electrical insulation is required between the electrodes 54a-b of the adaptive lens 40 for a metal wave spring 48 that is electrically conductive in contrast to a conventional O ring. The insulation element 52 that is shaped as a ring and can simultaneously be used as an installation aid satisfies this function. The thickness of the press ring 50 is preferably configured such that, on the installation of the lens module, its front surface is pressed as a block to the module housing 42 and the correct force of the wave spring 48 on the adaptive lens is thus automatically set in the typical range <10 N.

FIG. 7 shows a lens module 38 installed at an objective in a three-dimensional representation. The lens module 38 is arranged on an objective 60 or on its connection piece 62 (barrel). The designation objective 60 is a little imprecise since the combination of the objective 60 and of the lens module 38 can also be understood as an objective. No further distinction is made here; the objective 60 anyway has one or more lenses that cooperate with the adaptive lens 40 of the lens module 38 in the manner of an objective.

For the module integration, the lens module 38 is placed onto the connection piece 62 and is pressed on via a multiturn spring 64 and is thus held in position. The multiturn spring 64 is pressed and thereby tensioned on the opposite side toward a front screen 66, for example of an optoelectronic sensor 10 or, alternatively to the front screen 66, to a different element. An optional extraneous light protection or an extraneous light filter 68 can be arranged therebetween.

The multiturn spring 64 can be configured such that it is suitable for different objective distances or objectives 60 and a spring force is respectively produced on the adaptive lens 40 in the desired range. An exact alignment of the adaptive lens 40 at the optical axis of the objective 60 takes place via a clearance fit between the objective 60 or the connection piece 62 and a module housing 42 of the lens module 38. The assembly of the lens module 38 on the objective 60 can take place without tools. The electrodes 54a-b of the adaptive lens 40 are contacted by the connection lead 56. The lens module 38 is placed on and the first the multiturn spring 64 and subsequently the cover of the sensor 10 with the front screen 66 and the extraneous light filter 68 are placed on. The connection lead 56 is rotated into the correct position by the clearance fit in assembly.

1. A lens module that has a module housing having a base and a side wall, an adaptive lens variable in its focal length in the module housing, and a pressing element to hold the adaptive lens in the module housing,
wherein the pressing element has a wave spring.

2. The lens module in accordance with claim 1,
wherein the adaptive lens is one of a gel lens and a liquid lens.

3. The lens module in accordance with claim 1,
wherein the adaptive lens has at least one electrode and the lens module has a connection lead to contact the electrode from outside the module housing.

4. The lens module in accordance with claim 3,
wherein the connection lead is a flexible cable.

5. The lens module in accordance with claim 1,
that has a temperature sensor.

6. The lens module in accordance with claim 5,
wherein the temperature sensor is configured as a resistor on the connection lead.

7. The lens module in accordance with claim 1,
that has an insulation element between the adaptive lens and the wave spring.

8. The lens module in accordance with claim 7,
wherein the insulation element is simultaneously configured as an assembly element for inserting the adaptive lens into the module housing.

9. The lens module in accordance with claim 1,
that has a further pressing element for pressing the wave spring onto the adaptive lens.

10. The lens module in accordance with claim 1,
that has an insulation element between the adaptive lens and the wave spring, as well as a further pressing element for pressing the wave spring onto the adaptive lens, wherein the further pressing element, the wave spring, the insulation element, the adaptive lens, and the base are arranged above on another in this order.

11. The lens module in accordance with claim 10,
wherein the insulation element is simultaneously configured as an assembly element for inserting the adaptive lens into the module housing.

12. An objective having a lens module, the lens module having a module housing having a base and a side wall, an adaptive lens variable in its focal length in the module housing, and a pressing element to hold the adaptive lens in the module housing,
wherein the pressing element has a wave spring, the objective further having a second spring that presses the lens module onto the objective.

13. The objective in accordance with claim 12,
wherein the second spring is configured as a multiturn spring.

14. The objective in accordance with claim 12,
wherein a clearance fit for a rotation of a connection lead of the lens module into the correct position is provided between the lens module and the objective.

15. The objective in accordance with claim 12,
that has an extraneous light filter that is arranged above the second spring.

16. An optoelectronic sensor having at least one of a light transmitter and a light receiver as well as an objective disposed upstream of the light transmitter and/or the light receiver, the objective having a lens module, the lens module having a module housing having a base and a side wall, an adaptive lens variable in its focal length in the module housing, and a pressing element to hold the adaptive lens in the module housing,
wherein the pressing element has a wave spring, the objective further having a second spring that presses the lens module onto the objective.

17. The optoelectronic sensor in accordance with claim 16,
wherein the objective is pressed toward a front screen of the sensor by the second spring.
